(19) United States
(12) Patent Application Publication
(10) Pub. No.: US 2016/0339826 A1
(43) Pub. Date: Nov. 24, 2016

(54) COMBINATION TRAILER FOR A SMALL PERSONAL VEHICLE AND HOUSING UNIT

(71) Applicant: Dimitri BURI, Toronto (CA)

(72) Inventor: Dimitri BURI, Toronto (CA)

(21) Appl. No.: 14/716,005

(22) Filed: May 19, 2015

(51) Int. Cl. B60P 3/34; B60P 3/06

(52) U.S. Cl. CPC B60P 3/34; B60P 3/062

(57) ABSTRACT

The invention pertains to a combination small personal vehicle and housing unit trailer. More specifically the invention relates to a combination small personal vehicle and housing trailer wherein the housing unit is supported on top of the trailer frame and can accommodate a small personal vehicle for transport. Upon arrival at a destination the small personal vehicle can be unloaded from the housing unit and the housing unit can be disconnected and removed from the trailer frame. The housing unit includes a hitch for a small personal vehicle and the housing unit can then be towed by the small personal vehicle to a desired final location. In a preferred embodiment the housing includes a pair of skis coupled to the bottom thereof to facilitate the transportation of the housing unit over the snow. In this embodiment the floor of the housing unit also includes removable sections to facilitate the use of the housing unit for ice fishing.

### TECHNICAL FIELD

The present invention pertains to a combination trailer having a trailer frame and a removable self-supporting enclosure for transport of a small personal vehicle and functioning as a housing unit upon removal of the small personal vehicle. More specifically the invention relates to a combination small personal vehicle and housing trailer unit wherein the self-supporting enclosure housing unit is supported on top of a trailer frame, can accommodate a small personal vehicle for transport and function as a housing unit upon removal of the transported small personal vehicle.

### BACKGROUND

In some outdoor activities, there is a need to transport a small personal vehicle, such as a snowmobile or ATV, as well as a housing unit, such as an ice house or cabin, to a desired location. Traditionally the housing unit would be trailered on a flatbed trailer to the desired location and subsequently the small personal vehicle would be trailered. The housing unit would be left in the desired location for the duration of the season, for example, hunting season or ice fishing season, while the small personal vehicle would be transported to and from the location with each outing.

In some situations it is desirable to be able to tow the housing unit behind a small personal vehicle, especially when the final location is not easily accessible by automobile. As such, some housing units have been designed to be towable by a ATV or snowmobile.

There are trailers that have attempted to address these issues. Trailers which allow for the simultaneous transport of a housing unit and a small personal vehicle exist. One such example is a “pop up” ice fishing hut, such as the one manufactured by Road Kings Outdoors. The ice house portion of this design is essentially a tent structure which folds out and up from a flat folded position on top of a trailer bed and extends outwardly and up from the trailer bed to create a tent shelter. When the tent is not assembled, the small personal vehicle can be transported on top of a board which protects the tent fabric from the skis or treads of the recreational vehicle.

Additionally ATV trailers have been adapted to double as an ice hut. In these embodiments, the ATV is trailered within the housing unit of an ATV trailer. Upon unloading the small personal vehicle at the destination, an automobile is used to transport the housing unit to the desired location. The housing units are adapted for a particular uses, for example, if the housing unit will be used as an ice hut, the floor may be adapted to incorporate removable sections which allow access to the ice underneath the trailer. These embodiments do not allow removal of the housing unit from the trailer base. Furthermore the trailer is configured to be pulled by an automobile, and generally the trailers are too heavy to be pulled by a recreational vehicle.

There remains a need for a dual purpose housing unit and recreational vehicle trailer which allows the housing unit to be trailered by a recreational vehicle.

### SUMMARY

The present invention pertains to a combination small personal vehicle and housing unit trailer. More specifically the invention relates to a combination small personal vehicle and housing trailer wherein the housing unit is supported on top of the, trailer frame and can accommodate a small personal vehicle for transport. Upon arrival at a destination the small personal vehicle can be unloaded from the housing unit and the housing unit can be disconnected and removed from the trailer frame. The housing unit includes a hitch for a small personal vehicle and the housing unit can be towed by the small personal vehicle to a desired final location. In a preferred embodiment the housing includes a pair of skis coupled to the bottom thereof to facilitate the transportation of the housing unit over the snow. In this embodiment the floor of the housing unit also includes removable sections to facilitate the use of the housing unit for ice fishing.

### DESCRIPTION OF DRAWINGS

Preferred embodiments of the invention are shown in the drawings, wherein:

FIG. 1 shows a perspective view of the combination trailer in the assembled configuration;

FIG. 2 shows a side view in elevation of the combination trailer in the assembled configuration;

FIG. 3 shows a top view of the trailer frame with the outline of the housing unit shown in broken lines;

FIG. 4 shows a perspective view of the housing unit;

FIG. 5 shows a bottom view of the housing unit;

FIG. 6 shows the housing unit with a hatch in the open position and a recreational vehicle being loaded into the housing unit;

FIG. 7 shows the trailer frame with the hitch detached from the automobile and the housing unit partly removed therefrom;

FIG. 8 shows the housing unit in a partly removed from the trailer frame;

FIG. 9 shows the housing unit in a removed from the trailer frame and being towed by a small personal vehicle;

FIG. 10 shows the housing unit aligned to be loaded onto the trailer frame;

FIG. 11 shows the housing unit partly loaded onto the trailer frame; and

FIG. 12 shows a partial cutaway of the interior of the housing unit.

### DETAILED DESCRIPTION

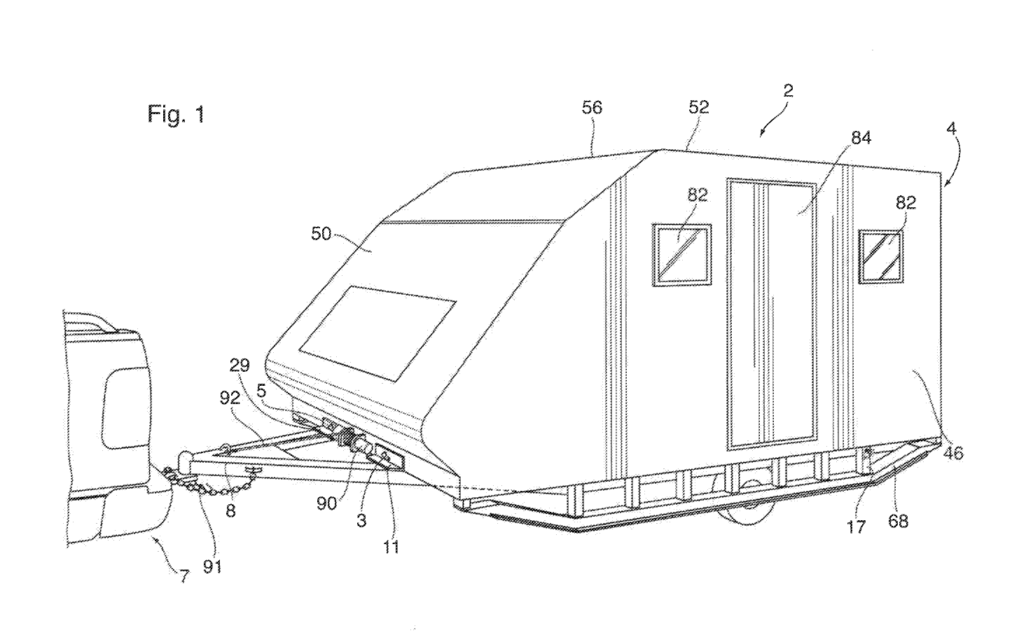

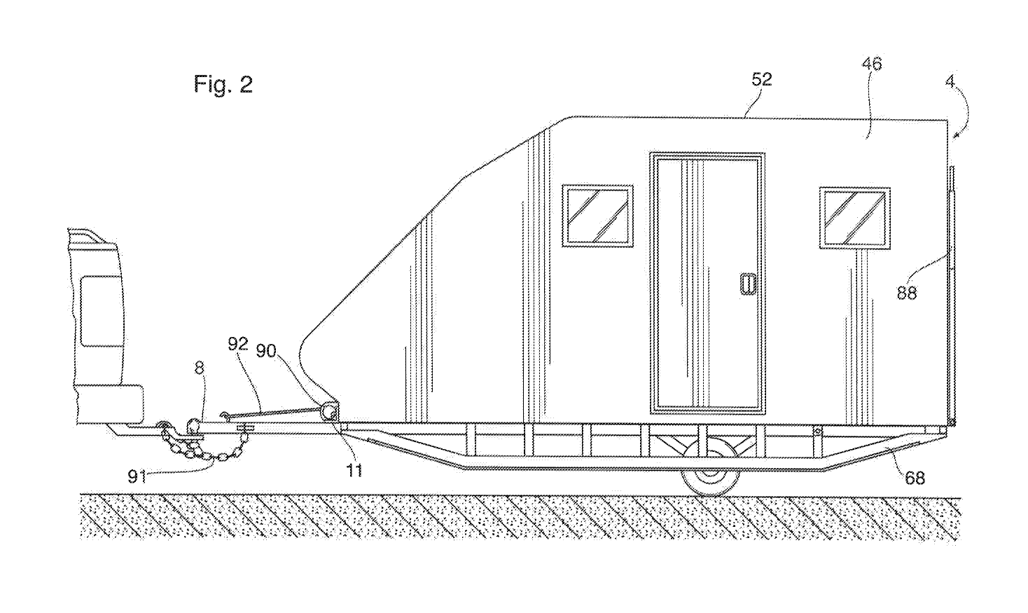

FIG. 1 shows a perspective view of a preferred embodiment of the combination trailer 2 of the present invention for trailering of a small personal vehicle and functioning as a housing unit upon removal of the small personal vehicle. As shown in FIGS. 2 to 4 the combination trailer consists generally of a housing structure 4 and trailer frame 6.

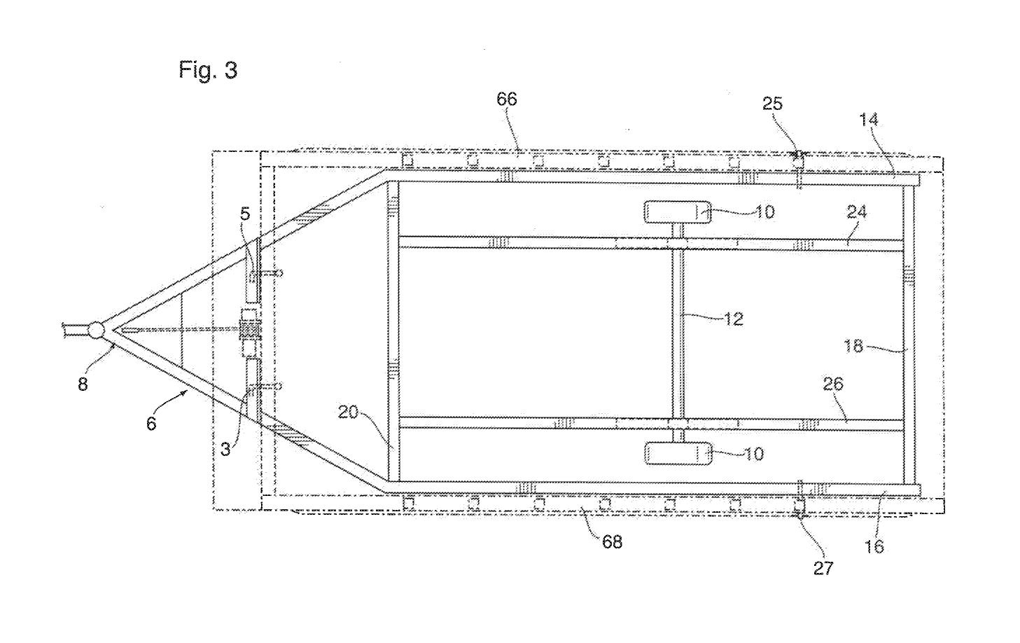

In the assembled configuration, shown in FIG. 1, the housing unit 4 is coupled to the trailer frame 6 and the trailer can accommodate a small personal vehicle within the housing unit. This facilitates the simultaneous transport of a housing unit 4 and a small personal vehicle. The trailer frame 6 includes a hitch assembly 8 to facilitate the coupling of the trailer frame 6 to an automobile 7 (shown in FIG. 1) for transport. As shown in FIG. 3, the trailer frame 6 includes a pair of wheels 10 coupled by an axle 12. Although the exact structural arrangement of the trailer frame can vary, the preferred embodiment includes a first side rail 14 and a second side rail 16 joined by a first strut 18 at the rear end of the side rails and a second strut 20 at the leading edge of the side rails. Extending from the leading edge of the side rails is a hitch assembly 8. Such an assembly is known to anyone skilled in the art and known designs can be adapted for this trailer. The trailer frame 6 further includes two longitudinal support rails 24 and 26 to which the axel 12 is rotatably coupled. These rails run from the forward strut 20 to the rear strut 18. The trailer frame can be made of any suitable material, for example, steel or aluminum.

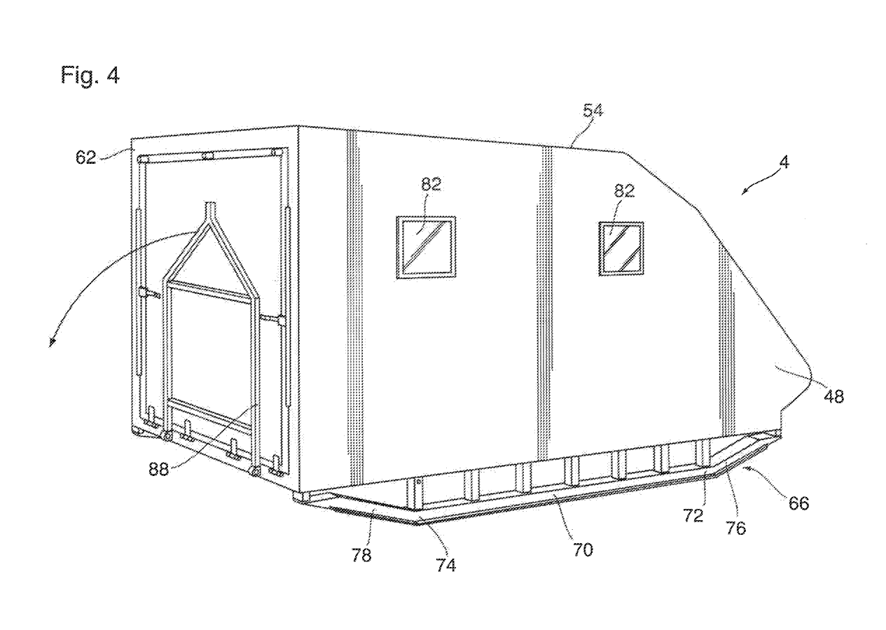

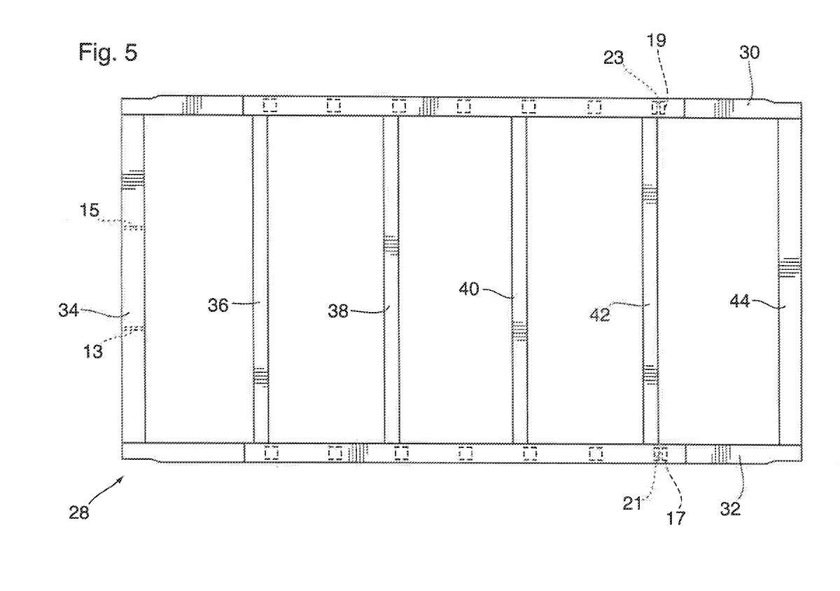

The housing unit 4 shown in FIGS. 4 and 5 has a floor system including a base frame 28 with a floor mounted to the top thereof as shown in FIG. 5. This base frame includes two side rails 30 and 32 coupled by a plurality of struts shown as 34, 36, 38, 40, 42 and 44. These struts are generally perpendicular to side rails 30 and 32. The struts 34, 36, 38, 40, 42 and 44 are predominantly coupled to the side rails 30 and 32, preferably by welding. Built up from this base frame 28 is a housing structure having a first side wall 46 (shown in FIG. 2) and a parallel second side wall 48 (shown in FIG. 4). The side walls 46 and 48 extend upwardly from and are supported by the side rails 30 and 32. The housing structure further includes a front wall 50 which extends between the first side wall 46 and a second side wall 48. This front wall can be perpendicular to the side walls or generally sloped as shown in the figures. Extending between the top edges 52 and 54 of side walls 46 and 48 respectively is a ceiling 56. Extending between the rear edges 58 and 60 of side walls 46 and 48 respectively is a rear wall 62. The first side wall 46, second side wall 48, front wall 50, ceiling 56, rear wall 62 and floor 45 combine in such a way that an enclosed structure is created.

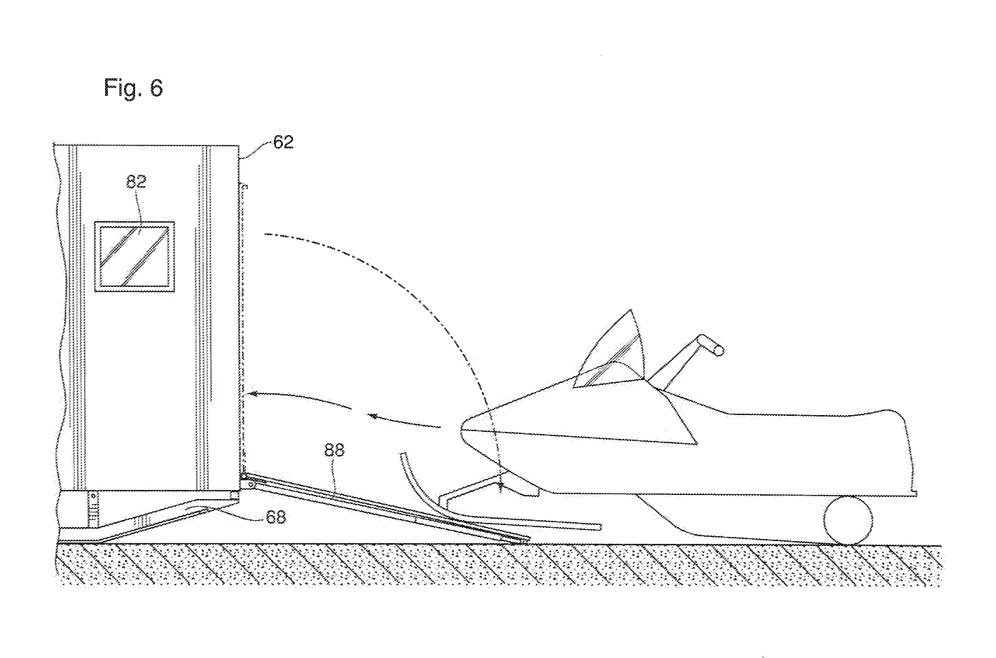

The rear wall 62 includes a hatch 64, hinged along the bottom edge to pivot downwardly such that the top edge contacts the ground while the pivot edge maintains in contact with the floor 45 of the housing unit 4. This hatch 64 acts as both a door and a ramp to allow a small personal vehicle such as a snow mobile or an ATV to be loaded into the housing unit 4 for transport (as shown in FIG. 6). In a preferred embodiment the hatch 64 is comprised of the entire rear wall 62, as is shown in the figures.

The housing unit 4 further includes a first ski 66 and a second ski 68, each coupled below and in a longitudinal direction to side rails 30 and 32 respectively. These skis facilitate a low friction method of moving the housing unit over a snow or ice surface.

In a preferred embodiment, the skis each include a flat base portion 70 which is parallel to the side rail of the housing frame, having a leading edge 72 and a trailing edge 74. Extending forwardly from the leading edge 72 is a first upwardly angled portion 76. Extending from the rear edge 74 of the base portion 70 is a second upwardly angled portion 78. The upwardly angled portion 76 helps to reduce drag when the housing unit is pulled along the snow in the forward direction while the upwardly angled portion 78 helps reduce drag of when the housing unit is pulled along snow in the rearward direction.

A plurality of vertical struts are used to couple the base portion 70 to a side rail of the housing unit frame 28. These vertical struts are permanently fixed to the ski at one end thereof. The opposite ends of the vertical struts can be permanently fixed to the side rail by methods such as welding or can be detachably coupled to the side rails, for example by a pin system to allow for removal of the ski from the housing unit.

A second hitch assembly 88 is configured to be coupled to the rear of the small personal vehicle. Configurations to facilitate this coupling can vary however, in a preferred embodiment, the hitch assembly is rotatably fixed to the rearward most strut 42 of the base frame 28. The housing unit 4 can then be pulled by the recreational vehicle to a desired location. Although the preferred embodiment shows the second hitch assembly 88 fixed to the rear of the housing unit 4, it can be appreciated that it could alternatively be coupled to the front of housing unit 4. Additionally, the hitch assembly could be detached from the housing unit 4 using a pin system.

The housing unit can further include windows 82 (shown in FIGS. 1 and 4) in the side walls as well as a door 84 (shown in FIG. 1) to allow an alternative entrance and exit into the interior of the hut. It may also be partially furnished on the inside to provide comforts upon arrival at a desired location, while still allowing room to transport a small personal vehicle.

When the combination trailer is in the assembled configuration, the housing frame 28 is coupled on top of the trailer frame 6. Although any known coupling system for trailers could be used, a pin system is preferred as it allows for easy coupling or detachment of the housing unit 4 to the trailer frame 6. In a preferred embodiment, the pin system would be comprised of two attachment points at the front of the housing unit, and two at the rear. The two attachment points at the front of the housing unit are shown in FIG. 1. Two pins 3 and 5 are coupled through holes 7 and 9 in the L brackets 11 and 29. These brackets and holes are on opposing side of the winch 90 and align with holes 13 and 15 in the housing frame (shown in FIG. 5). The rear attachment pins are located at opposing rear struts 17 and 19, shown in FIG. 5. Holes 21 and 23 in struts 17 and 19 respectively align with holes 25 and 27 in the rear side rails of the trailer frame. A pin can be pushed through the aligned holes and secured to couple the housing unit to the trailer.

In the assembled configuration, the side rails 30 and 32 lie to the outsides of the trailer frame side rails 14 and 16 respectively (as shown in FIG. 3). This allows the skis 66 and 68 to span the width of the trailer frame, providing some lateral stability of the housing unit on the trailer frame and spacing the base portion 70 of the skis from the ground for transport (as shown in FIG. 1). The trailer frame side rails 14 and 16 are provided with holes which align with holes in the skis and accommodate removable pins having a locking ring to tie the trailer frame side rails and skis together for transport and allow for removal of the housing unit from the trailer frame.

In this assembled configuration, the struts 34, 36, 38, 40, 42 and 44 of the base frame 28 cooperates with the longitudinal support rails 24 and 26 of the trailer frame 6 to provide a series of supports to the floor 45. Together these supports provide structural stability to the floor to bear the weight of a small personal vehicle such as a snowmobile or an ATV.

When in the assembled configuration, the hatch 64 can be lowered and a small personal vehicle shown in FIG. 6 can be loaded into the housing unit 4. Transport within the housing unit 4 protects the small personal vehicle from dirt, stone chips, and the elements during transport.

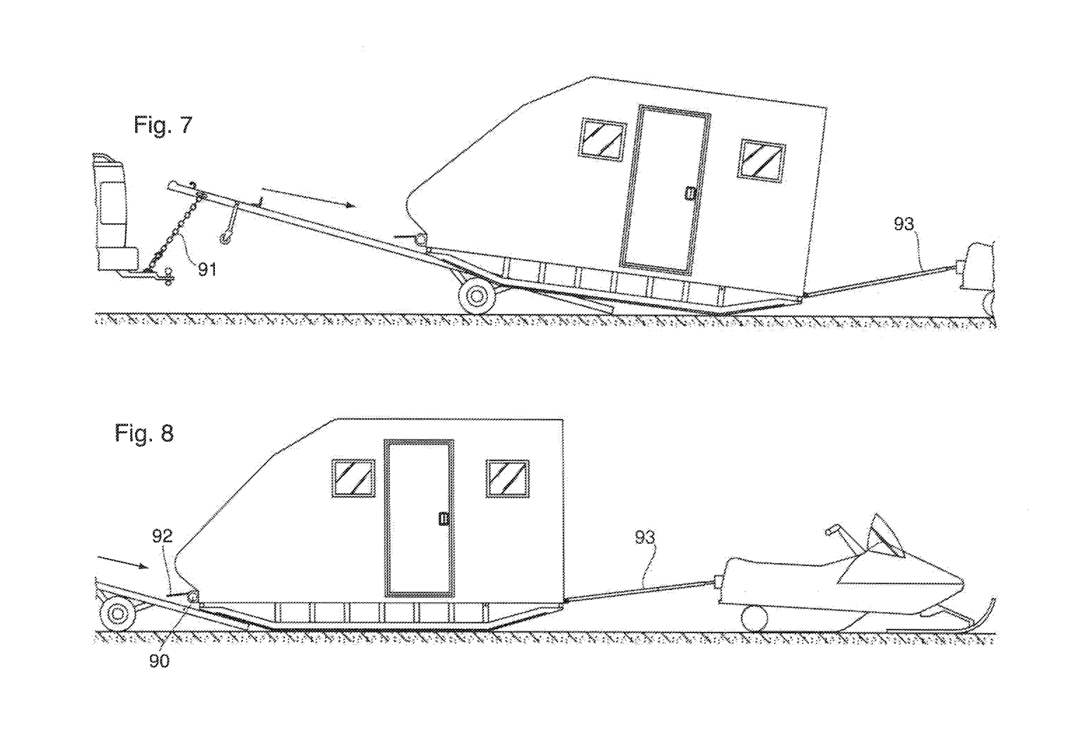

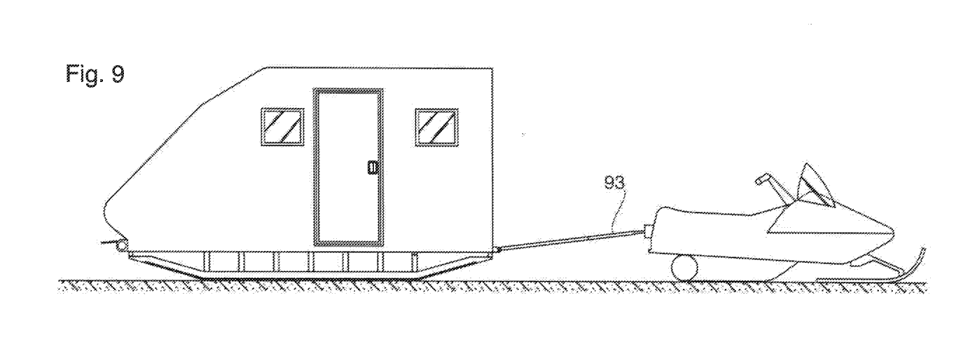

Upon arrival at a desired site, the small personal vehicle is unloaded from the housing unit 4 by lowering the hatch 64 and sliding it down the ramp provided by the hatch 64. To remove the housing unit 4 from trailer frame, the trailer frame 6 is disconnected from the automobile at the hitch and the frame of the housing unit 4 is then disconnected from the trailer frame 6. This allows the trailer frame to tilt rearwardly as shown in FIG. 7. The safety chains 91 are left attached to the automobile to secure the trailer frame to the automobile while still allowing the frame to tilt. Using the second hitch assembly coupled to the rear strut 44 of the housing frame, the housing unit 4 can be pulled off the trailer frame using a small personal vehicle, as shown in FIGS. 7 and 8. As shown in FIGS. 7 and 8, the winch cable is disengaged to unload the housing unit. The housing unit 4 can then be pulled to a desired final location by the small personal vehicle as shown in FIG. 9.

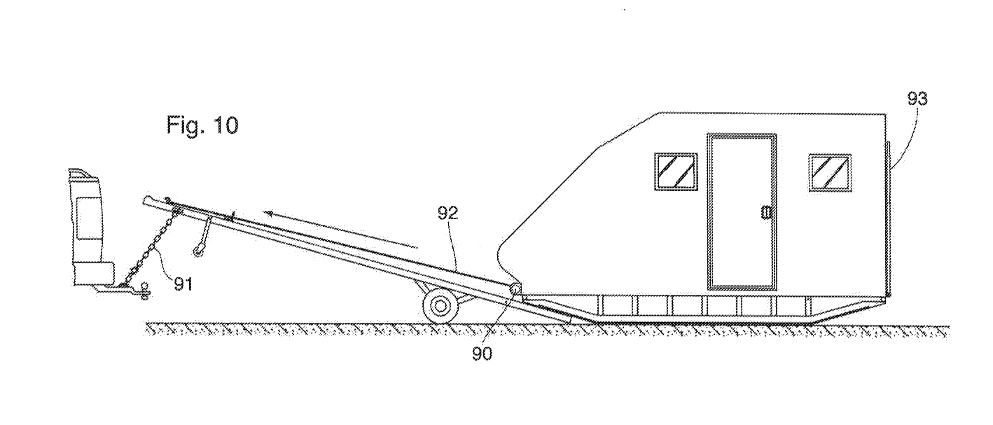

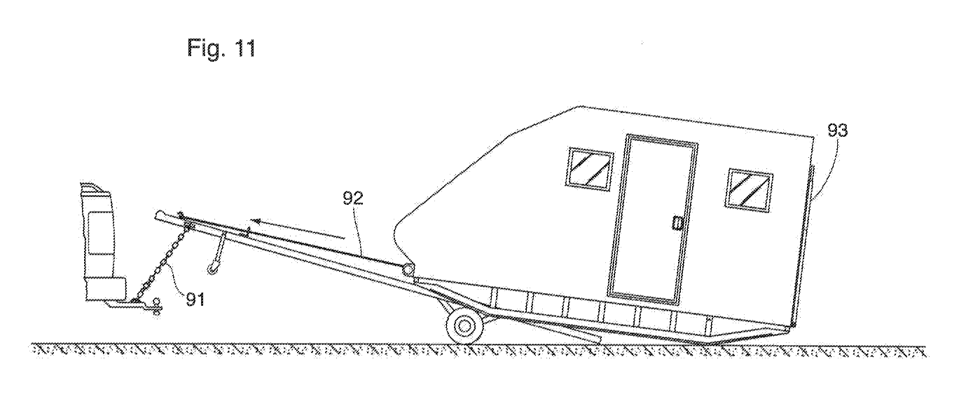

In order to load the housing unit back onto the trailer frame, the housing unit is aligned with the trailer frame and the small personal vehicle is disconnected from the second hitch assembly 93. This second hitch assembly is then returned and fixed in a storage position against the hatch 64. The trailer frame is coupled to the automobile using the safety chains 91, but remains disconnected at the hitch. This allows the trailer frame to tilt rearwardly. As shown in FIG. 10, the winch cable 92 is connected to a hook or loop 95 at the front of the trailer frame and the winch 90 is then activated. As the winch 90 winds in the winch cable 92, the housing unit is pulled onto the trailer frame as shown in FIG. 11. Once the front of the housing unit abuts the L brackets 11 and 29, the winch is deactivated and the pins are used to secure the housing unit to the trailer frame. Alternatively, the winch could be coupled to the front of the trailer frame 6 and the winch cable would be coupled to a coupler provided on the forward most strut 34 of the base frame 28 of the housing unit 4.

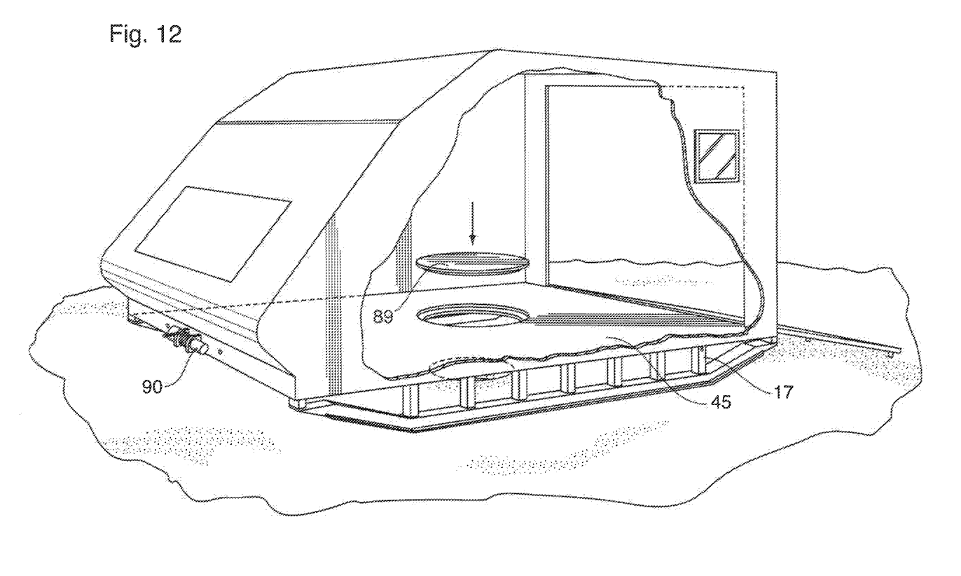

FIG. 12 illustrates an example of the interior of the housing unit 4. The floor of the housing unit can be equipped with a removable section 89 to access to the ground or ice below the housing unit. These removable sections of flooring provide for a user to access the ground beneath the housing unit which is particularly useful if the housing unit 4 is used as an ice hut when ice fishing.

This particular trailer/housing unit combination is most effective when the housing unit is made out of lightweight material to facilitate easy trailering of the ice hut using a small personal vehicle. One example of a lightweight housing unit would be one made of sheet aluminum walls and an aluminum frame.

The combination of trailer frame and housing unit is advantageous in that the housing unit can be trailered to a desired site with the small the personal vehicle stored therein. This arrangement protects the small personal vehicle from the elements and facilitates a simultaneous transportation of a lightweight housing unit which can be easily pulled by the small personal vehicle to a specific desired location.

The scope of the claims should not be limited to the preferred embodiments set forth in the examples, but should be given the broadest interpretation consistent with the description as a whole.

1. A combination small vehicle and housing trailer comprising
a trailer frame having at least two wheels and an attachment arrangement for detachably coupling the trailer frame to an automobile for transport;
a housing unit, having on interior and exterior, configured to house in the interior thereof, a small personal vehicle for transportation;
said housing unit is detachably coupled to and configured to be supported on top of said trailer frame and further includes a hitch assembly mounted to said housing unit to allow the housing unit to be pulled by a small personal vehicle when the housing unit is detached from the trailer flame.

2. A combination trailer as claimed in claim 1, wherein
said housing unit further including two skis mounted on alternative sides to a bottom frame of said housing unit on alternate sides thereof; and said hitch assembly is mounted between two skis.

3. A combination trailer as claimed in claim 2, wherein when said housing unit is attached to said trailer frame, the base frame of said housing unit is reinforced by said trailer frame.

4. A combination trailer as claimed in claim 3, wherein
said housing unit includes a winch and winch cable coupled to a frame of the housing unit to facilitate coupling and forward movement of the housing unit relative to the trailer.

5. A combination trailer as claimed in claim 4, wherein
said housing unit further includes a rear hatch to facilitate loading and unloading of a small personal vehicle;
said hatch being rotatably coupled to the housing unit such that it is movable between a closed position where it is in line with a forms part of a rear wall of the housing unit and an open position, where it forms a ramp between the ground and housing unit.
